(19) United States
(12) Patent Application Publication
(10) Pub. No.: US 2008/0288300 A1
(43) Pub. Date: Nov. 20, 2008

(54) DATA PROCESSING SYSTEM AND METHOD

(75) Inventors: James M. Emling, Dousman, WI (US); Ken Hunt, Grafton, WI (US); Craig Passler, Waterford, WI (US)

Correspondence Address: FOLEY & LARDNER LLP, 777 EAST WISCONSIN AVENUE, MILWAUKEE, WI, 53202-5306, US

(73) Assignee: Zywave, Inc.

(21) Appl. No.: 12/122,470

(22) Filed: May 16, 2008

Related U.S. Application Data
(63) Continuation-in-part of application No. 11/701,970, filed on Feb. 2, 2007.
(60) Provisional application No. 60/939,324, filed on May 21, 2007.
(60) Provisional application No. 60/764,899, filed on Feb. 3, 2006.
(60) Provisional application No. 60/775,482, filed on Feb. 21, 2006.
(60) Provisional application No. 60/802,353, filed on May 22, 2006.
(60) Provisional application No. 60/802,671, filed on May 23, 2006.
(60) Provisional application No. 60/812,689, filed on Jun. 9, 2006.

(51) Int. Cl. G06Q 40/00

(52) U.S. Cl. 705/4

(57) ABSTRACT

A data processing system including a database, a file server coupled to the database, a template engine coupled to the file server. The template engine being configured to create a plurality of insurance brokerage industry templates. The system further including an application service provider interface logic coupled to the file server and the template engine. The application service provider interface logic being configured to receive commands via a communication network from a client device to access an open platform template library in the database and retrieve one of the plurality of insurance brokerage industry templates.

### CROSS-REFERENCE TO RELATED PATENT APPLICATIONS

The present application claims priority to U.S. Prov. Patent Application Ser. No. 60/939,324, entitled “Data Processing System and Method,” filed May 21, 2007 and claims priority as a Continuation-In-Part to U.S. application Ser. No. 11/701,970, entitled “Data Processing System and Method,” filed Feb. 2, 2007, pending, which claims priority to U.S. Prov. Patent Application Ser. No. 60/802,353 entitled “Data Processing System and Method,” filed May 22, 2006; U.S. Prov. Patent Application Ser. No. 60/802,671, entitled “Data Processing System and Method,” filed May 23, 2006; U.S. Prov. Patent Application Ser. No. 60/812,689, entitled “Data Processing System and Method,” filed Jun. 9, 2006; U.S. Prov. Patent Application Ser. No. 60/775,482, entitled “Data Processing System and Method,” filed Feb. 21, 2006; and U.S. Prov. Patent Application Ser. No. 60/764,899, entitled “Data Processing System and Method,” filed Feb. 3, 2006, all of which are hereby incorporated by reference herein.

### BACKGROUND

The present disclosure relates generally to the field of data and file management. More particularly the present disclosure relates to an application service provider's template engine generator and data management system.

It is often desirable to share data through a communication network. For example, various application service providers (“ASPs”) exist which provide computer-based services to customers (i.e., users) of the ASP over the Internet. The computer-based services may include providing access to one or more software applications which execute on servers operated by the ASP and which are provided to the customers via the Internet. In order to effectively utilize the services provided by ASPs, it is often necessary for the users of the ASP to upload and download files to and from the ASP's central data center. As a further example, it is often desirable for companies to collaborate in real-time with its customers (or suppliers or other parties), such as on the creation of certain documents, presentations, or other files. Often, the process of sharing data through a network can become very tedious, particularly when the user desires to upload or download multiple files. Additionally, it is often tedious to access the files from other applications that may reside on the user's computer (e.g., for purposes of reading or modifying the file, for purposes of attaching the file to an e-mail, and so on). A challenge that has been encountered in providing a more seamless solution is that it is often desirable for customers to be able to use such files in combination with other network resources, such as applications or files available via a company intranet. Also, it is often desirable for multiple users (e.g., multiple employees at a company) to have common access to such files. Further, it would be advantageous to have a template engine generator, which could supply customized templates to the end user. It would be desirable to provide a more seamless integration of data files provided by an ASP's server with other resources available to users of the ASP.

Although certain features and advantages are described, it will be appreciated that the teachings herein may also be used to implement systems and methods that have other features and advantages different than those described.

### SUMMARY

One embodiment relates to a computer-implemented data processing system including a database, a file server coupled to the database, a template engine coupled to the file server, and an application service provider interface logic coupled to the file server and the template engine. The template engine being configured to create a plurality of insurance brokerage industry templates. The application service provider interface logic being configured to receive commands via a communication network from a client device to access an open platform template library in the database and retrieve one of the plurality of insurance brokerage industry templates.

One embodiment relates to a computer-implemented data processing method for database management including storing at least a data file in an application service provider database and storing at least an insurance brokerage industry template in the application service provider open platform template library. The method further includes receiving a template command from a client devices to an application service provider server and transmitting the insurance brokerage industry template.

One embodiment relates to a computer-implemented data processing system including a database, a file server coupled to the database, a template engine coupled to the file server, an open platform content template logic, and an application service provider interface logic coupled to the file server and the template engine. The template engine being configured to create a plurality of insurance brokerage industry templates. The application service provider interface logic being configured to receive commands via a communication network from a client device to access at least one of the plurality of insurance brokerage industry templates and to cooperate with the client device to cause the at least one of the plurality of insurance brokerage industry templates to be displayed on the client device.

### BRIEF DESCRIPTION OF THE DRAWINGS

The application will become more fully understood from the following detailed description, taken in conjunction with the accompanying drawings.

FIG. 1 is an illustration of a system for facilitating data management, according to one embodiment.

FIG. 2 is an illustration of a system for facilitating data management, according to a more detailed example embodiment.

FIG. 3 is an expanded illustration of a system for facilitating data management, according to one embodiment.

FIGS. 4A-B are illustrations of an Application Service Provider's content generation template engine, according to one embodiment.

FIG. 5 is a screen shot of a log-in screen for a content generation template engine, according to one embodiment.

FIG. 6 is a screen shot of a financial industry template, according to one embodiment.

FIG. 7 is a screen shot of search function for a financial industry template, according to one embodiment.

FIG. 8 is a screen shot of search function for a financial industry template, according to one embodiment.

FIG. 9 is a screen shot of a favorites option for a financial industry template, according to one embodiment.

FIG. 10 is a screen shot of a selection basket for a financial industry template, according to one embodiment.

FIGS. 11A-11B are illustrations of the merger field functionality for a financial industry template, according to one embodiment.

FIG. 12 is a screen shot of a distribution calendar option for a financial industry template, according to one embodiment.

FIG. 13 is a screen shot of a template grouping option for a financial industry template, according to one embodiment.

FIG. 14 is screen shot of an express campaign option for a financial industry template, according to one embodiment.

FIGS. 15A-15C are screen shots of a report designer window provided by the Application Service Provider, according to one embodiment.

FIG. 16 is a screen shot of a data explorer window for designing a customized template, according to one embodiment.

FIG. 17 is a screen shot of a properties window for designing a customized template, according to one embodiment.

FIG. 18 is a screen shot of a filter designer window provided by the Application Service Provider, according to one embodiment.

FIG. 19 is a screen shot of a filter properties window, according to one embodiment.

FIGS. 20A-20B are illustrations of the expression feature, according to one embodiment.

FIGS. 21A-21B are screen shots of an operator section and a functions section of an expressions editor window, according to one embodiment.

FIG. 22 is a screen shot of a schedule explorer window, according to one embodiment.

FIG. 23 is a screen shot of a publication explorer window, according to one embodiment.

### DETAILED DESCRIPTION OF THE EXEMPLARY EMBODIMENTS

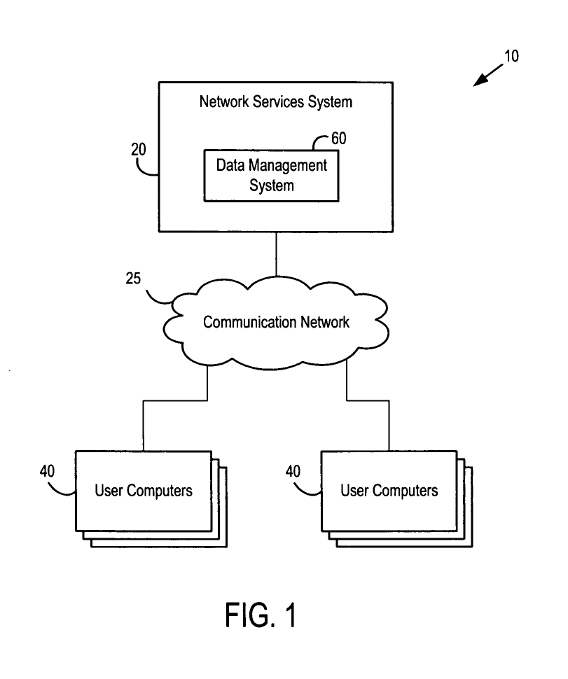

Referring now to FIG. 1, an embodiment of a system 10 is shown. The system 10 comprises a network services system 20 and user computers 40. Network services system 20 may, for example, comprise a computer system (e.g., one or more networked servers) operated by an application service provider or other entity. Network services system 20 may provide computer-based services to users through communication network 25, such as the Internet. User computers 40 may comprise individual or multiple computers connected to the communication network 25, individual or multiple computers connected to the communication network 25 through another network (e.g., an enterprise intranet), or other arrangements.

Network services system 20 permits user computers 40 to access data in the data management system 60 through computer network 25. The data may, for example, be accessed using a browser such as Internet Explorer®. (Internet Explorer® is a registered trademark of Microsoft Corporation.)

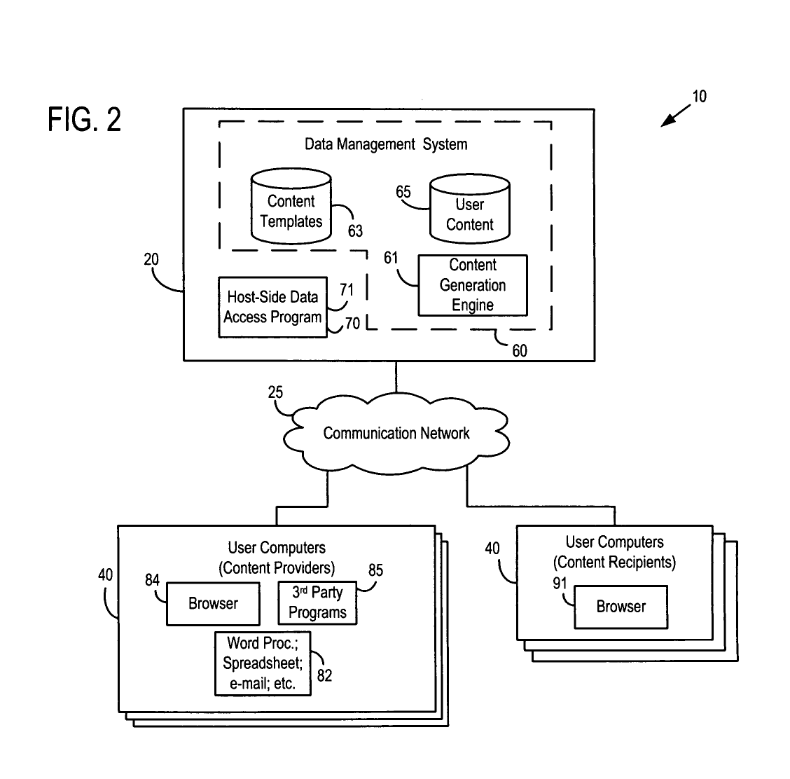

Referring now to FIG. 2, FIG. 2 is similar to FIG. 1 except that it provides a more detailed example. In the example of FIG. 2, network services system 20 is shown as providing a content management system 60. Content management system 60 may be used to manage content such as documents (e.g., word processing documents, spreadsheet documents, graphics documents, etc.), media (e.g., music, video, etc.), or other content (e.g., technical data, medical/patient data, purchasing data, customer data, etc.). For purposes of providing an example, it will be assumed herein that content management system 60 is used in connection with managing documents.

The users using user computers 40 may be entities (e.g., corporate entities, governmental entities, non-profit entities, and so on) and/or users that are private individuals (e.g., individuals acting on their own behalf). In the example of FIG. 2, user computers 40 may be associated with content providers and/or user computers 40 may be associated with content recipients. The content providers may, for example, be businesses that provide services to entities outside their institutional boundaries (e.g., to customers or clients). In such an embodiment, network services system 20 may be used to facilitate the delivery of content generated by one or more content providers to their customers or clients. Alternatively, if the customers or clients have less frequent interactions with data management system 60, the customers or clients may prefer to access data management system 60 with a web browser, since it does not involve installation of additional software. As will be appreciated, in at least some instances, the content may be provided to the client or customer in another manner (e.g., hardcopy format).

The content may be generated by the users using user computers 40, by data management system 60, and/or by another system. In the example of FIG. 2, the content is generated at least partially by data management system 60. Thus, content management system 60 comprises content generation engine 61, content templates database 63, and user content database 65. (Herein, the term “database” refers to any data storage system). Content generation engine 61 may be configured to access templates stored in templates database 63 and user-provided content stored in user database 65 and, using the templates and user-provided content, generate content that is suitable for presentation to the customers or clients. For example, if the content is documents, content generation engine 61 may be configured to access document templates stored in database 63 and generate documents based on the templates. The templates may provide generic information, and generation engine 61 may be used to generate custom documents based on the templates and based on context-specific information stored in user content database 65.

For example, if a report is to be generated by content generation engine 61, then a content provider may store a spreadsheet file in user content database 65 that may contain raw data to be used by content generation engine 61 to populate a report template to generate the report. The content provider may also store a word processing document containing other customized text for the report. Content generation engine 61 may then process the information contained in the spreadsheet file and/or the word processing file to generate the customized report. Other data may also be incorporated, for example, to incorporate logos or other branding information of the content provider. Content generation engine 61 may also access other sources of information and use that information to process information provided by the content provider. For example, if the spreadsheet specifies that a certain quantity of services has been provided, then content generation engine 61 may access a pricing engine that generates a price for each unit of services, so that the report includes a total fee for the services provided. Once the content (in this example, the report) is generated, it may be stored in user content database 65.

The content may be accessed by the content provider using their browser 84 or third party programs 85. For example, the content provider may access the report to make final changes to the report before it is presented to the content recipient (e.g., to manually insert additional information into the report, to delete irrelevant text, etc.). The content provider may wish to modify a spreadsheet or the word processing document and then regenerate the report. In FIG. 2, user computer 40 is shown as comprising other generic programs 82 which may be used to access and modify the content in data management system 60 (e.g., word processing programs, spreadsheet programs, e-mail programs, presentation programs, media players, and so on). The report may also be accessed by another access program 84 (e.g., a web browser, such as Internet Explorer using user interface 50) or by third party programs 85.

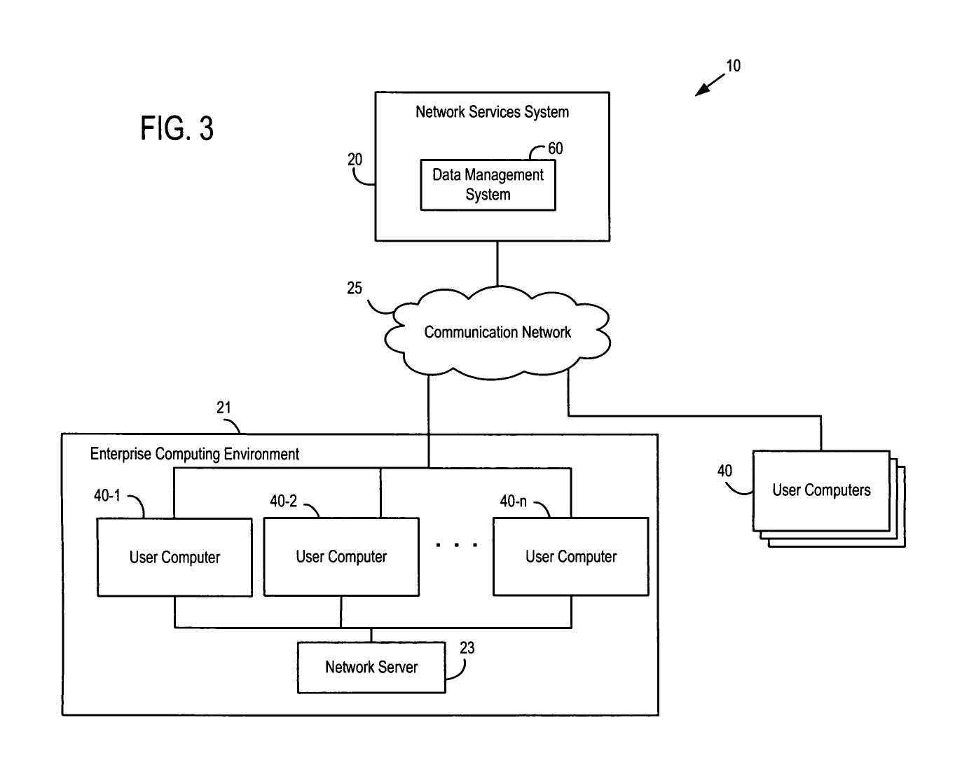

Referring now to FIG. 3, an embodiment of system 10 is shown. System 10 comprises network services system 20 and user computers 40. Network services system 20 permits user computers 40 to access data in data management system 60 through computer network 25. In an exemplary embodiment, an enterprise computing environment 21 is shown. Enterprise computing environment 21 includes a client network server 23 and a plurality of user computers 40-1, 40-2 and 40-n. In an exemplary embodiment, client network server 23 stores data files that are not part of the ASP services. Client network server 23 is configured to store files that are not stored on network services system 20. Plurality of user computers 40-1, 40-2 and 40-n are utilized by individual employees of a single customer of the ASP to access the ASP services, network services system 20 and client network server 23.

Enterprise computing environment 21 allows the users to utilize network services system 20 while not utilizing client network server 23. In an exemplary embodiment, the user could utilize both client network server 23 and network services system 20. This flexibility may create significant cost and technological advantages for a customer of the ASP because the customer may have common access to files by multiple different users in the enterprise while at the same time permitting the files to be accessed by the ASP. The customer may not need or may be able to reduce the size of the customer's client network server 23. In an exemplary embodiment, the customer can reduce their client network server 23 demands because of a reduction in storage or network capacity.

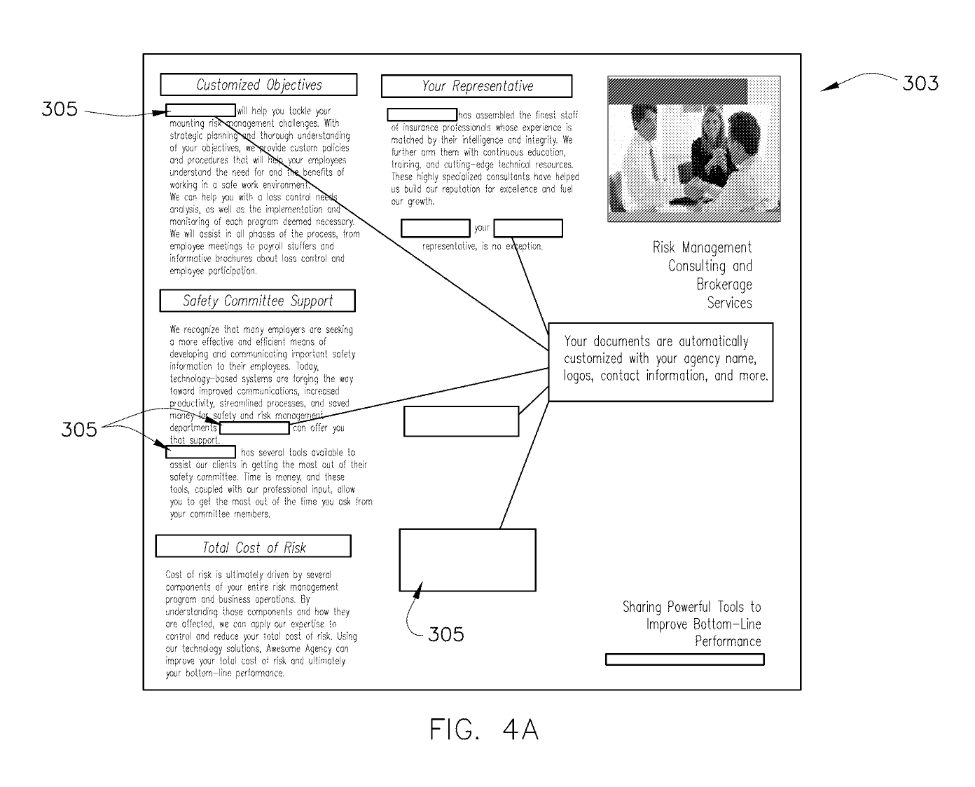

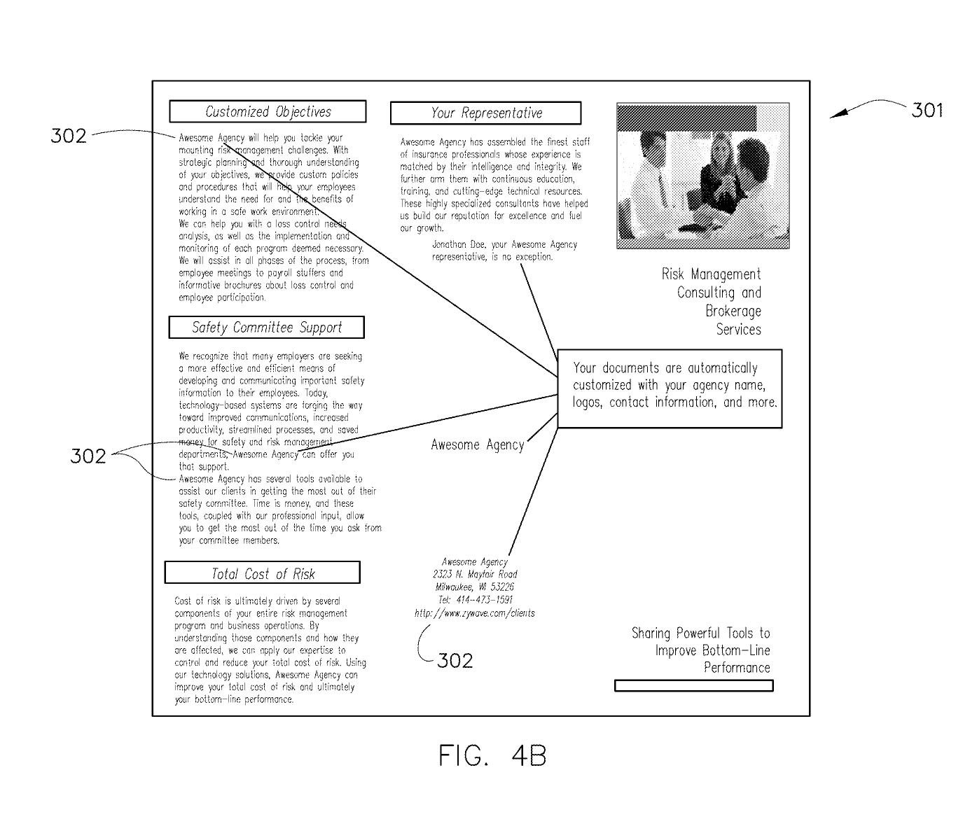

Referring now to FIGS. 4A-4B, FIGS. 4A-4B show that in an exemplary embodiment, data management system 60 includes content general engine 61 which is configured to create a template 303. The number of templates 303 available in the ASP's template library is limited only by the amount of storage capacity in the ASP's database. Templates 303 contained within content generation engine 61 may be customized and distributed as discussed later in this description.

In an exemplary embodiment, template 303, as shown in FIG. 4A, may be customized for the financial industry by populating data fields 305. It should be noted that while template 303 finds particular utility in the financial industry, templates 303 in the template library, including template 303, could be designed for other industries and uses. Template 303 is customized by inserting a client data 302 in data fields 305. As shown in FIG. 4B, after inserting client data 302 in data fields 305, a brochure 301 is created based on the merge fields functionality of the system. The merge fields functionality merges data fields 305 and client data 302 in template 303.

In an exemplary embodiment, client data 302 may include the company's name, the company's address, the company's telephone number, the company's facsimile number, the company's web address, the company's logo, the company's slogan, the company's marketing message, a client specific message, a target market specific message, or any combination thereof.

An ASP's client may assign one or more users to the administrative function. These administrators or administrative users may grant access to other users on an as needed basis. An administrative user may also have the ability to set up email functions for users, subscribe to campaigns, upload new templates as needed, and/or create custom merge fields. In an exemplary embodiment, a campaign includes various templates 303 that are sent on a preset schedule to a customer of the client. In another exemplary embodiment, the administrative user may customize client data 302 for a marketing campaign or specific targeted solicitation.

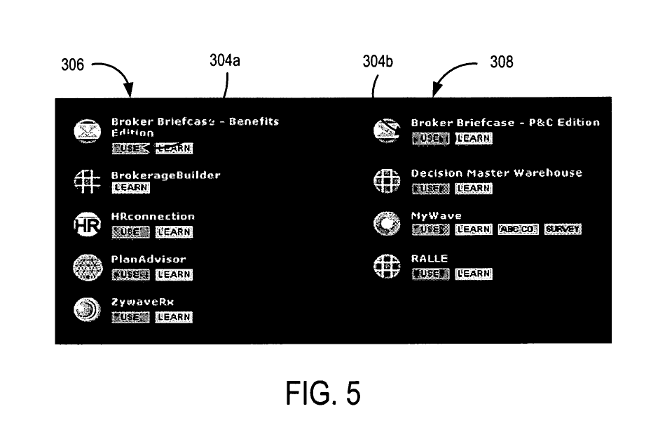

In an exemplary embodiment, access to financial templates 303 are attained by accessing the ASP's portal. In an exemplary embodiment, the ASP's portal may prompt a person for their username and/or password. However, if the user has saved their username and password while logging in during a previous session then the user will be immediately directed to the screen shown in FIG. 5. The user may then choose a use button 304a to select a financial industry benefits section 306 or a use button 304b to select a financial industry property and casualty edition section 308 as applicable. In an exemplary embodiment, financial industry benefits section 306 and financial industry property and casualty edition section 308 are part of insurance brokerage industry templates 303 written by industry experts that are available to clients of the ASP.

A financial industry's benefits edition may contain numerous combinations of template categories. In an exemplary embodiment, a benchmark surveys and statistics category may be created, which provides the user with industry related statistical information. In another exemplary embodiment, an employee communications & education category may be created, which provide industry training to employees utilizing various communication methods. In another exemplary embodiment, a sales tools category may be created, which provides the user a variety of programs to better interact with their customers. In yet another exemplary embodiment, a compliance & plan designs category may be created, which ensure that industry standards and rules are being met and provide the user with a plan to follow. In a further exemplary embodiment, an employer education category may be created, which provides up to date training for employees. The ASP's products, which includes access to a variety of industry related programs; or a wise & well section, which educates the user regarding healthcare consumerism. Template categories in a financial industry's property and casualty edition may contain any combination of the following: cost containment (which provides the user with information relevant to helping their clients maintain control of their costs); employee communications (which provides a variety of templates to communicate with clients); print proposals (which provides a means to print proposals for clients); sales concepts (which provides a variety of sales methods and ideas for the user to apply to their client base); loss control (which provides various methods for controlling agency loss for their clients); marketing tools (which allows the user better communication strategies to apply to their clients); studies and surveys (which provides the ASP's products which includes access to a variety of industry related programs); OSHA compliance (which provides detail regarding compliance with the regulations and standards of the federal agency of Occupational Safety and Health Administration's standards); commercial risk summaries and checklists (which provides detailed data on various insurance risks associated with the user's clients); personal lines marketing tools; auto insurance; homeowner's insurance; personal insurance; employee benefits prospecting materials; renewal materials; plan strategies; wise and well; human resources; employee handbook and policies; retirement; state specific compliance; federal compliance; benefit statements; presentations and proposals; health awareness; employer education; employer newsletters; employee benefit worksheets; benefit announcements and information; employee communication and education; benchmark surveys and statistics; contingency planning; workers compensation statutes; safety policies; safety manuals; safety awareness; certificates of insurance; claims cost containment; client servicing; and/or any other template category known by one skilled in the art.

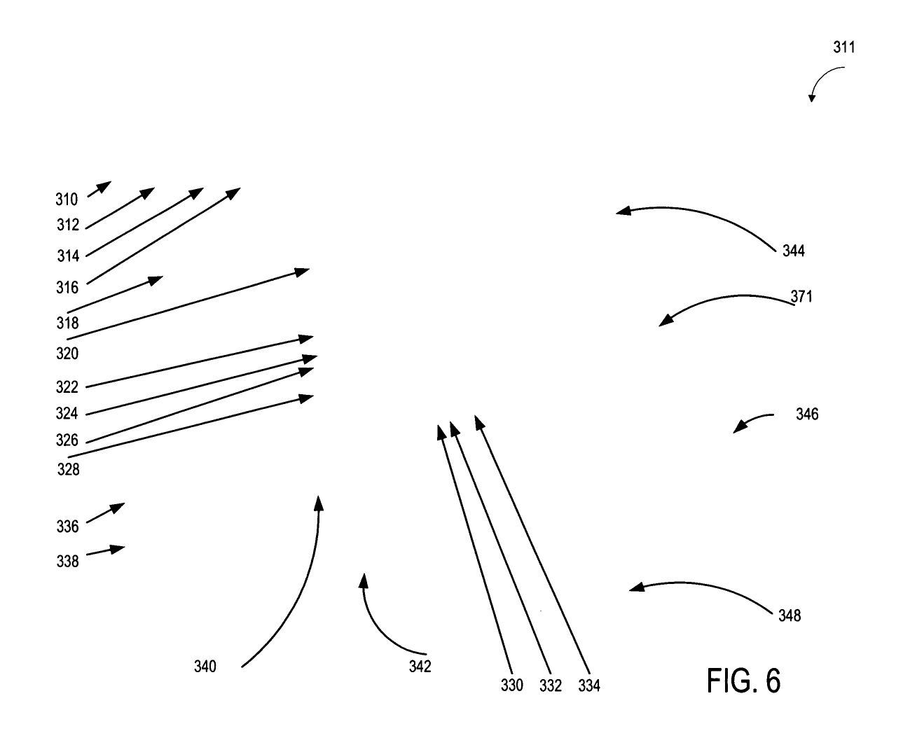

In an exemplary embodiment, templates 303 may be chosen for customization in a variety of manners. The user may browse for template 303, perform a search for a specific template 303, or select a previously utilized template 303 that has been marked as a favorite. As shown in FIG. 6, a template details page 311, which is a portion of a financial industry's application screen may have a prospect button 310, a retain button 312, a renew button 314 and a templates button 316. Prospect button 310 will initiate a prospect wizard, which can be utilized to find templates 303 that are appropriate for attaining new business. Retain button 312 allows the user to select templates 303 that pertain to the retention of current clients, and by selecting renew button 314, a user is directed to templates 303 that are beneficial in the renewal process for clients. By selecting templates button 316, a user may browse all templates 303 available by category.

According to an exemplary embodiment, a user may be taken to template details page 311, once the performance of a search is completed and/or the initiating of a browse option is requested. Template details page 311 includes a thumbnail image of a template selected 318, a template title 320, and a brief description of a template 322. Template details page 311 also includes a template identification number 324 which is a unique number identifying template 303, a source identifier 326, which designates the creator of the document, and a return to search results link 328. The document action buttons may be used to preview or select template 303. A star icon 330 is used to denote template 303 as a favorite. Star icon 330 allows a user to add template 303 to a list of favorite templates. A magnifying glass icon 332 represents a preview, which allows a user to view template 303 with all merge codes available. A basket icon 334 represents selection basket. By selecting basket icon 334, template 303 is added to a selection basket for distribution at a later time.

In another exemplary embodiment, template details page 311 includes a merge fields option 336. Merge fields option 336 allows a user to view which fields may be automatically customized. A template ratings preview 338 is utilized to show a rating of template 303. In an exemplary embodiment, the rating system is on a four star scale and applied to prospect, renewal, and retain categories. Templates 303 in the system are assigned a rating by the ASP, the open platform template provider, the end user, the client of any combination thereof. The user is allowed to assign ratings to custom templates 303 that the user themselves have created. In an exemplary embodiment, a templates popularity section 340 lists the number of times template 303 is used within a time interval (i.e. day, week, month, year, etc.). The usage is tracked by this program and is automatically reported to an end user on a predetermined or customized schedule. In another exemplary embodiment, a related templates link 342 is shown. Related templates links 342 allows the user to go directly to other templates 303 that are related to a current one in terms of template subject matter. Further, template detail page 311 may include a quick search screen 344, an advanced keyword search screen 371, a selection basket screen 346, and a my favorites screen 348. Quick search screen 344 directs the user to an area of the program that is used to search all templates 303 available. Selection basket screen 346 is a function that allows the user to add templates 303 to a list for later customization and distribution. My favorites screen 348 is an option that allows the user to place template 303 on their list of favorites for ease of access in the future.

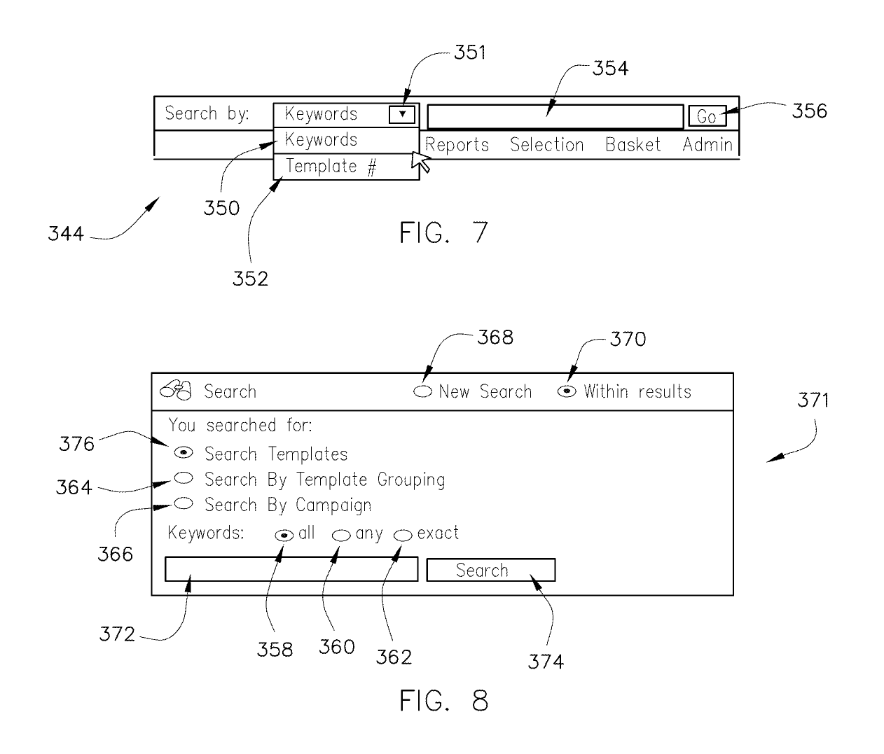

FIG. 7 shows a close up view of quick search screen 344. A quick search function allows a user to select a keywords option 350 or a template number option 352 in a drop down menu 351. In an open text box area 354, a user may enter a keyword to search or template identification number 324. A search is performed once a user selects a go button 356. In FIG. 8, advanced keyword search screen 371 is illustrated, according to an exemplary embodiment. Advanced keyword search screen 371 allows a user to search keywords with an “all” toggle switch 358, an “any” toggle switch 360, or an “exact” toggle switch 362. Additionally, the user may search within a “template groupings” toggle switch 364 and “express campaigns” toggle switch 366. To perform a search on all possible financial industry templates 303, a user may select a “new search” toggle switch 368. To search only within results from a previous search or browse category, a user would select a “within results” toggle switch 370. The user may also select a “search templates” toggle switch 376, a “search by template grouping” toggle switch 364, or a “search by campaign” toggle switch 366. Once keywords have been entered in an open text box 372, a search button 374 may be selected to begin a search. Further, refinement of a search may be achieved by searching again and selecting “within results” toggle switch 370. To start all over and begin a new search, the user would select “new search” toggle switch 368.

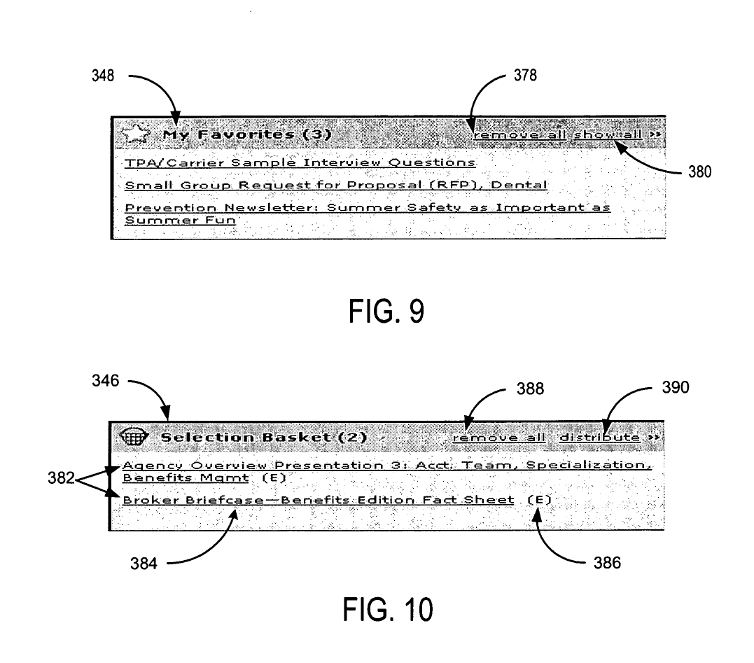

Referring to FIG. 9, a my favorites screen 348 is illustrated. My favorites screen 348 may be used if a user wants to annotate specific templates 303 as favorites. First a user locates template 303 they would like to have marked as a favorite. The user selects star icon 330 and may choose to select a remove all 388 to clear their list of favorite templates 303, or a show all 380, which links them to a page that lists all of the selected favorite templates 303.

Referring to FIG. 6, an exemplary embodiment is shown where a user determines which templates 303 they want to distribute to clients. The user may then select the appropriate templates 303 and place them in selection basket 346. To add template 303 to selection basket 346, the user selects basket 334. Template 303 is then added to selection basket 346.

Referring now to FIG. 10, an exemplary embodiment of a close-up view of selection basket 346 is shown. A template list 382 in selection basket 346 is illustrated. A template title 384 is shown with a language letter 386 which designates the language template 303 is written in. It should be noted that template 303 can be customized for any language desired by the end user. A user may click a remove all button 388 to clear all templates 303 in selection basket 346. Once templates 303 are placed in selection basket 346, templates 303 may be customized and distributed. A user may then select a distribute link 390.

A user has a variety of options for distributing customized documents. In an exemplary embodiment, a user may choose to post a document to the ASP's website. A user's clients may then access a document via an Internet instead of storing the document on a local hard drive or intranet. In an exemplary embodiment the distribution may be an attachment to an email sent to a user's client. In a further embodiment, distribution may be to open and print a completed document or save a document to a hard drive of a user's computer.

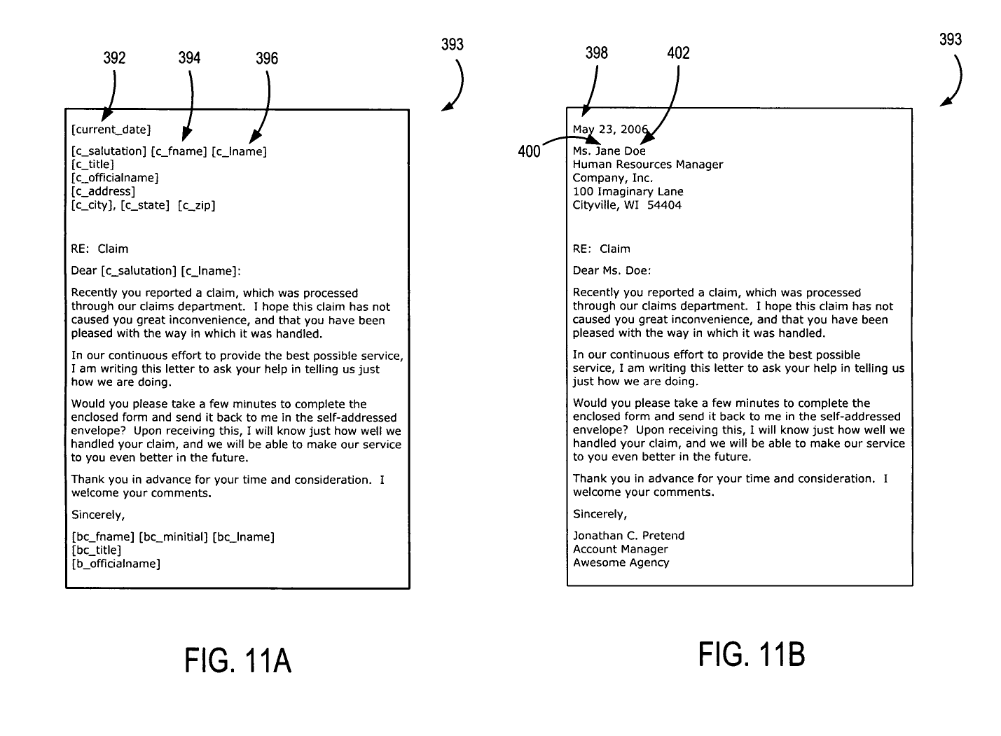

Referring now to FIGS. 11A-11B, a customization process for financial insurance brokerage industry templates is accomplished by using merge fields. FIG. 11A is an exemplary embodiment of a template 393 before the merge fields are populated. Merge fields may be represented in brackets. In an exemplary embodiment, a [current_date] 392 represents the day's current date, a [c_fname] 394 represents a client's first name, and a [c_lname] 396 represents a client's last name. The data for these merge fields is inputted by a user in a setup wizard. When a financial industry template software sees the brackets, it looks to a database to find information a user has input for the particular field in brackets. The merge fields are then populated by the financial industry software with the correct data. In FIG. 11B template 393 is shown with merge fields populated. In an exemplary embodiment, a May 23, 2006 date 398 has replaced [current_date] 392 in FIG. 11A. Likewise, a Jane 400 has replaced [c_fname] 394 and a Doe 402 has replaced [c_lname] 396 in FIG. 11A.

In FIG. 12, an exemplary embodiment of a distribution calendar 403 is shown. Customized template 393 may be distributed to clients. After distributing template 393, a user may choose to track the distribution with distribution calendar 403. A view option 404 allows a user to choose between an “all distributions” toggle switch 406 or a “my distributions” toggle switch 408, which are user created distributions. A show option 405 allows a user to choose between a “future distributions” toggle switch 410 to view those documents that have been prepared but not yet shared with clients, or a “past distributions” toggle switch 412. “Past distributions” toggle switch 412 shows documents that have already been shared with clients. In an exemplary embodiment, information in distribution calendar 403 may be divided into any combination of the following categories: a distribution date category 414, a tracking info category 416, document name category 418, and distribution method category 420. It should be noted that each category may be sorted by any information contained within the category.

A user may group templates 393 so that a standard set of customized templates 393 exist for any number of given clients. In an exemplary embodiment, a close up view of a template groupings provision 422, is shown in FIG. 13. The user may select a “my groups” toggle switch 424 to view template groupings, which were created by the user, or select a “my agency groups” toggle switch 426 to view template groupings that a user's agency has created, or select an ASP toggle switch 428 to view preset template grouping created by an ASP or the open platform template provider. Once a user determines a group of templates they wish to use, they may put them in selection basket 346, customize, and distribute as previously described.

In an exemplary embodiment, a user may choose to provide a customized set of templates 393 to their clients on a preset schedule, or an express campaign. Templates 393 and schedule are chosen by the ASP or the open platform template provider. Administrators or administrative users of a financial industry software have authorization to subscribe to or cancel express campaigns. A user views a list of available express campaigns by subject matter and selects the express campaign they wish to utilize. Once one or more express campaigns are selected, the express campaigns may be made available to other users within an agency. In FIG. 14 an exemplary embodiment of an express campaigns 431 is illustrated. Information presented regarding express campaign 431 may be any combination of the following: a title 430; an explanation of a campaign 432; and a number of documents contained within a campaign 434. To obtain information regarding express campaign 431, a user may then choose a view a document icon 436 with a document details section 438. A red flag 440 is used to denote a user's subscription to express campaign 431.

In an exemplary embodiment, users of financial industry software have many customization options available: editing existing templates for a user's agency content; creating new templates that may be uploaded for use by the user's agency; and/or creating various reports regarding available template usage information.

In an exemplary embodiment, the ASP provides the architecture for an open platform template providers to create completely customizable templates 393. The open platform template providers may be individual experts in a particular field, companies specializing in a particular area (i.e. dental, health, life), individuals with expertise in a particular industry, companies specializing in a particular industry (i.e. law firm, automotive companies, universities) or any combination thereof. In will be appreciated by those skilled in the art that there are numerous individuals or companies that can provide valuable insight to clients and would therefore be a candidate to become an open platform template providers.

The open platform template providers may customize everything from the look and feel to the types of data fields included in template 393. In an exemplary embodiment, the data elements used to create reports (e.g., brochures, documents, letters, invoices, etc.) from templates 393 are divided into three main sections including: a data category; a data view; and a data field. The data category is the most general data element, and the open platform template provider is allowed one data category per main report. In an exemplary embodiment, more than one data category may be used with a sub-report feature. The data view is a sub-category of the data category, and a data category may contain multiple data views. Finally, the data field is an individual type of data item found in each data view, and the data view may contain multiple data fields (e.g., account name, address, city, state, zip, phone number, etc.). The data category and data view elements narrow the pool of data from which the report can be generated and the data field element contain the specific information from which template 393 is populated to create a report.

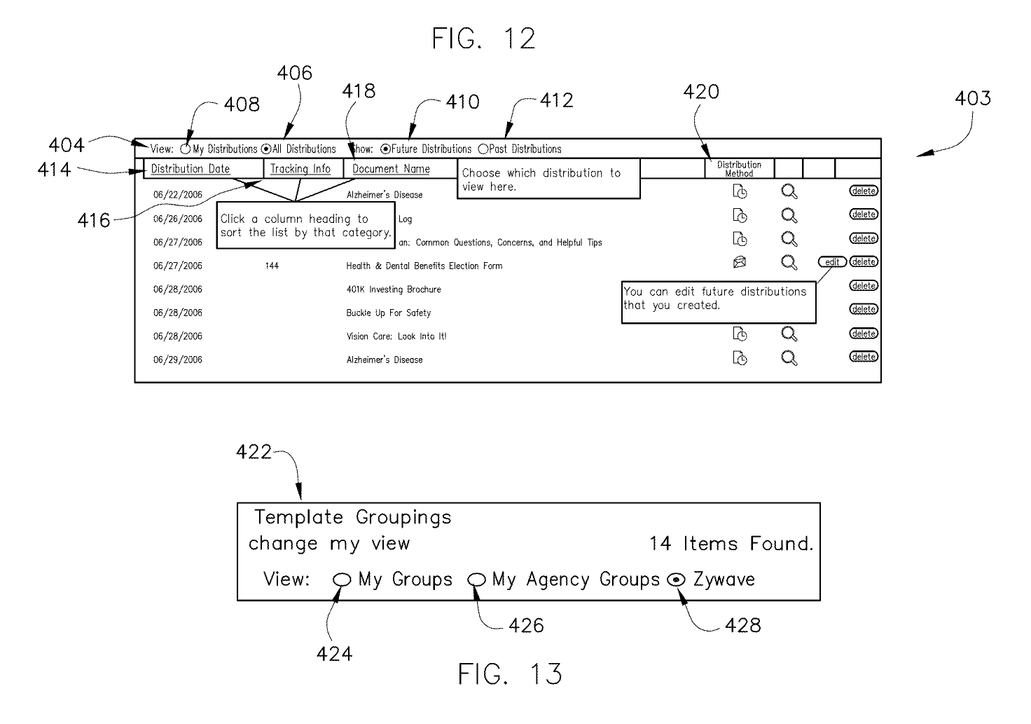

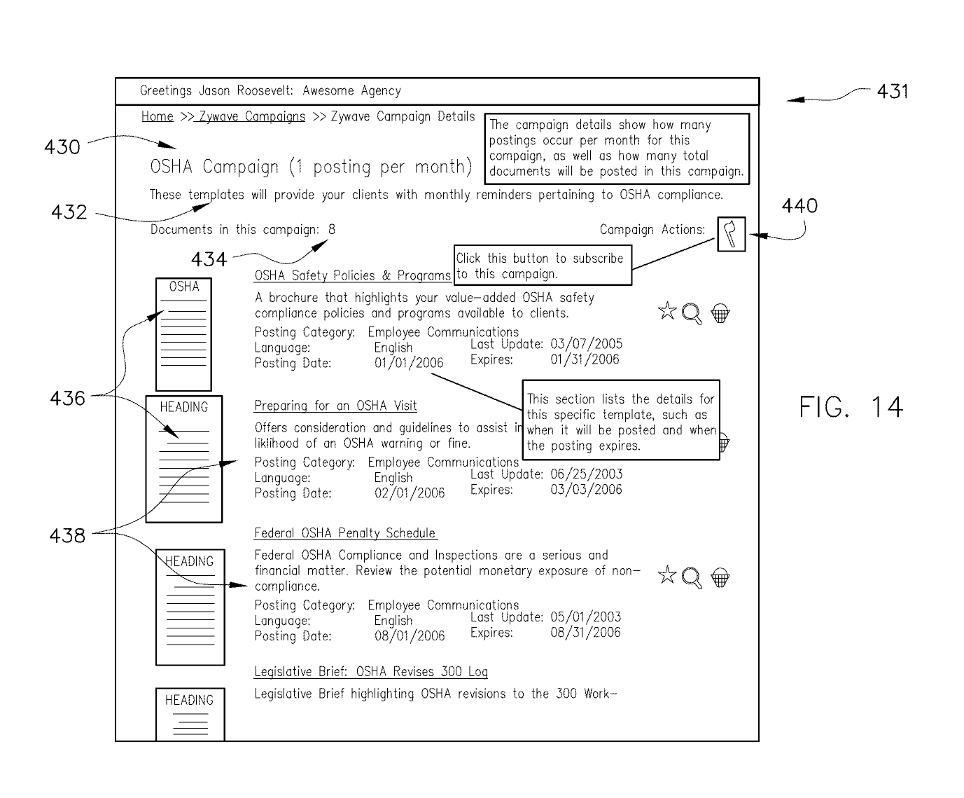

Referring to FIGS. 15A-15C, in an exemplary embodiment, the ASP provides a design window 500 where the open platform template provider creates customized template 393. Design window 500, may be segregated into numerous sections. FIG. 15A shows design window 500 segregated into a page header/footer section 502 and a details section 504. In an exemplary embodiment, several other sections could be added including: a report header/footer section; a group header/footer section; and a sub-report section. In the report header/footer section the open platform template provider can enter information to be included at the beginning and end of the reports produced by template 393. In page header/footer section 502, the open platform template provider can enter information to be displayed on the top and bottom of each page, respectively. In the group header/footer section the open platform template provider can enter headers and footers for each group created within a report. In details section 504, the open platform template provider either manually enters detailed information or selects the associated fields in this section that are filled in from an external data sources, such as a database. Finally, in the sub-report section the open platform template provider may embed a report within another report so that the sub-report can access a data category that is different from the data category accessed by the report. FIG. 15B shows a sample report 510 that groups the contents of the report by state. Sample report 510 contains state names 512 as group headers where the contents of each group corresponds to state names 512. FIG. 15C shows a sample detail design 520 that would be located in detailed design section 504 and a corresponding sample detail output 530. Sample detail output 530 shows the report that would be generated by template 393.

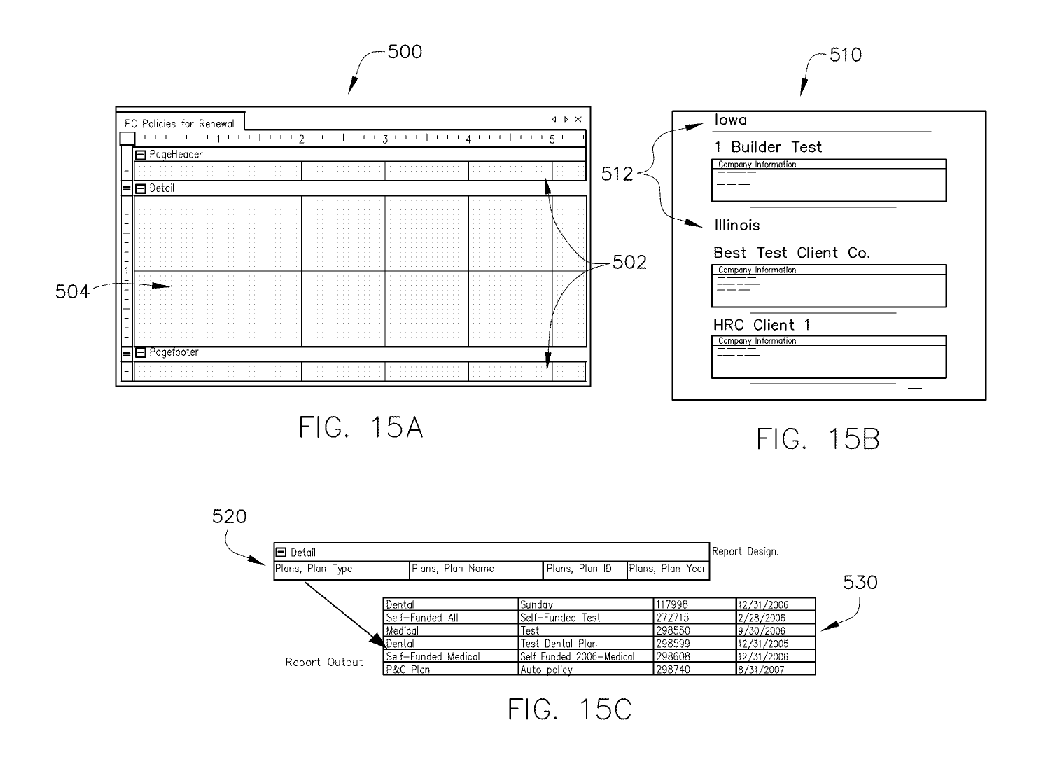

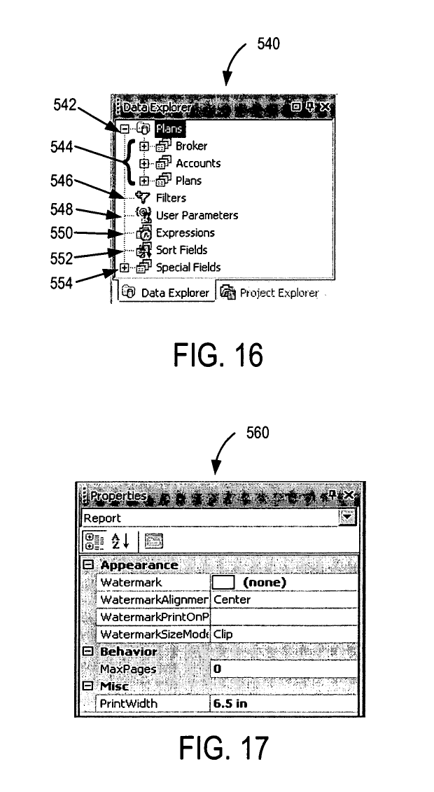

After starting with a blank template the open platform template provider begins by adding various items (e.g., images, text, data fields, etc.) and objects (e.g., label, text, images, lines, etc.) into the sections. In many instances the open platform template provider will want objects to be static (unchanging) so that they appear the same with every use of template 393. The open platform template provider may also add dynamic (changing) items to template 393 that will change based on the information in found in a referenced data source (e.g., database, user input, formulas or expressions, application settings, data from other ASP applications, data from applications external to the ASP, etc.). Referring to FIG. 16, a data explorer window 540 gives the open platform template provider access to all the different types of data that can be used in template 393. Data Explorer window 540 shows a open platform template provider selected data category 542 which contains a plurality of data views 544. The open platform template provider can drill down into the plurality of data views 544 to access the data fields. Data explorer window 540 gives the open platform template provider access to a filters item 546, an open platform template provider parameters item 548, an expressions item 550, a sort fields item 552, and a special fields item 554. Filters item 546 is configured to allow the open platform template provider to limit the data in the report based on one or more criteria. Open platform template provider parameter item 548 is configured to allow the recipient of the report to limit the data based on one or more criteria defined by the open platform template provider. Expressions item 550 is configured to allow the open platform template provider to manipulate text and numeric data fields to achieve a desired output on a report. Sort fields item 552 is configured to allow the open platform template provider to sort the report by any of the fields that are used in the report. Special fields item 554 is configured to allow the open platform template provider to include items that are not directly tied to the data in the report including the following special fields:

| Field | Description |
|---|---|
| Current Date | Inserts the date that the report was generated in mm/dd/yyyy |
| | format. |
| Current Date Time | Inserts the date and time that the report was generated in |
| | mm/dd/yyyy HH:MM AM/PM format. |
| Current Time | Inserts the time that the report was generated in HH:MM AM/PM |
| | format. |
| Report Name | Inserts the name of the report as it was entered when the |
| | report was created or renamed. |
| Last Modified Date | Inserts the date that this report was last saved in mm/dd/yyyy. |
| Last Modified Date | Inserts the date and time that the report was last saved in |
| Time | mm/dd/yyyy HH:MM AM/PM format. |
| Last Modified Time | Inserts the date and time that the report was last saved in |
| | HH:MM AM/PM format. |
| Running Page Number | Inserts a page number for the current page in the report. |
| Running Page Of Total | Inserts the page number of the current page and the total |
| Pages | number of pages in the report (such as 2/15). |
| Total pages | Inserts the number representing the number of pages in the |
| | report. |

A toolbox window is configured to give the open platform template provider access to tools and objects that can be inserted into template 393. The objects accessible through the toolbox are static elements, such as static text, images, lines, etc. The following is a list of the tools that are available in the toolbox window:

| Tool | Description |
|---|---|
| Pointer | Use this tool when working in the report designer window. You use the |
| | pointer to select and move objects on the report designer window. |
| Label | Use this tool to create a basic, static text label. For example, if you |
| | create a report that's broken into columns, you might use a Label as the |
| | header for a column or row. |
| Rich Text | Use this tool to insert more fully-formatted text into your report. In fact, |
| | you can create a rich-text format file (.rtf) in Microsoft ® Word and |
| | upload it directly into this tool. |
| Check box | Use this tool if you want to create a form in a printed report for users to fill out. |
| Line | Use this tool to insert a line into your report. You may use this line to |
| | separate sections of a report, for example. |
| Shape | Use this tool to draw a rectangle, rounded rectangle, or ellipse on your |
| | report. This is used most often to draw a border around another element |
| | in the report. |
| Image | Use this tool to insert an image into your report, such as a company logo. |
| Pagebreak | Use this tool to insert a manual page break into your report. For |
| | example, if you want each account's information on its own page, you |
| | would insert a pagebreak object in after the account information as you |
| | design the report. |
| Subreport | Use this tool to insert a report within your report. For example, if you |
| | have an Account information report, you may want to insert an Account |
| | Contact sub-report within it. |

Referring to FIG. 17, a properties window 560 is configured to allow the open platform template provider to view and modify the properties of a particular item or object when that item or object is selected. Each type of object or item has different properties and most properties may be changed manually within properties window 560. However, some properties may change automatically based on other actions taken by the open platform template provider. In these exemplary embodiments, these tools are customizable by the open platform template provider and supported by the ASP's platform. The ASP's platform supports these template 393 during development and after uploading to the ASP's system.

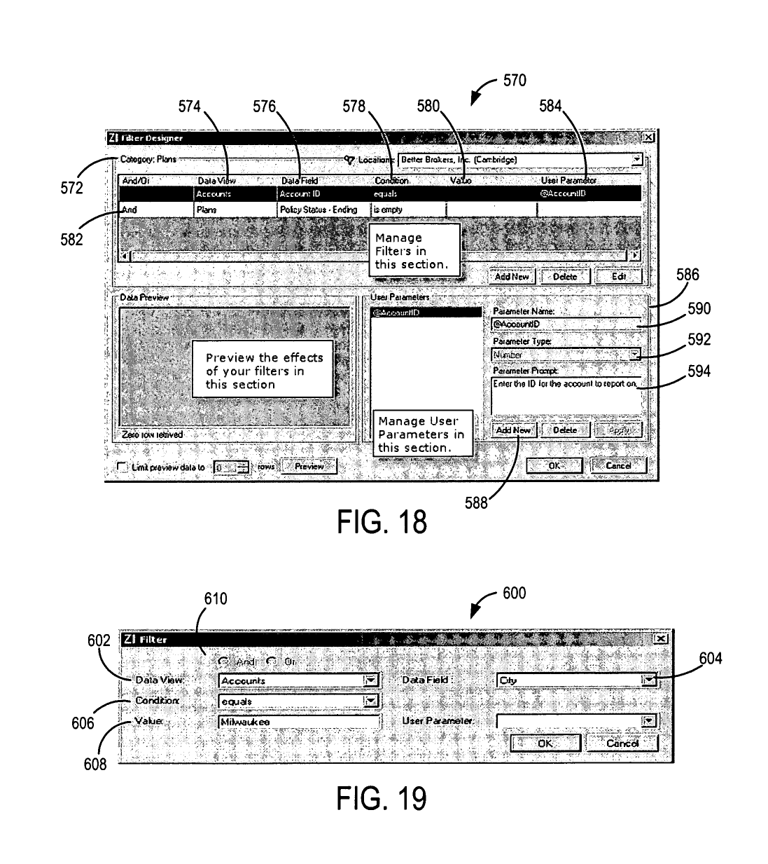

Referring to FIG. 18, the ASP provides a filter designer window 570 accessible from data explorer window 540 by selecting either filters item 546 or open platform template provider parameters item 548. By default, reports will include all records for the data view selected by the open platform template provider. However, in many cases, the open platform template provider may not want a report to include all records from the open platform template provider's data. Instead, the open platform template provider may want to limit the results based on certain criteria. In filter design window 570, the open platform template provider can create filters or set up open platform template provider parameters for the data view chosen and limit the data for the report based on one or more criteria (e.g., state, city, specific recipient, etc.). FIG. 18 shows a category section 572 where the plans data category has previously been associated with the report to be generated. Category section 572 provides a data view heading 574, which shows all the data views within the plans data category for which filters have been created. In this case, the plans data category has two data views under data view heading 574 with filters, an accounts data view and a plans data view. Category section 572 provides a data field heading 576, which shows the particular data field whereon conditions will be placed for purposes of filtering. Category section 572 provides a condition heading 578 and a value heading 580. Condition heading 578 shows the condition set on the selected data field and value heading 580 shows the value associated with the condition if applicable. For example, FIG. 19 shows a filter setup window 600 where the open platform template provider selects a filter data view 602 from the list of available data views. The open platform template provider then selects a filter data field 604 from the list of available data fields within the selected data view. The open platform template provider then selects a filter condition 606 and enters a filter value 608. In FIG. 19 the open platform template provider has selected the accounts data view, the city data field and set a condition and value so that only the accounts that are located in Milwaukee will be used in the report. Therefore, accounts located in Chicago, Madison or any city other than Milwaukee will not be used. An And/Or feature 610 may be used to designate whether the filter will be conjunctive (And) or disjunctive (Or) in relation to any other filters defined for a particular category. Category section 572 provides an And/Or heading 582 to identify whether the filter has been set to combine conjunctively or disjunctively. Category section 572 provides a open platform template provider parameter heading 584 which displays the open platform template provider parameters associated with a particular filter.

The open platform template provider may setup open platform template provider parameters so that the recipients, or end users, of the report may dynamically narrow the results within the data associated with the report. In filter design window 570 of FIG. 18, the open platform template provider can create or edit open platform template provider parameters in open platform template provider parameter section 586. To create a new open platform template provider parameter the open platform template provider selects an add new button 588, enters a name for the new open platform template provider parameter in a parameter name field 590 and selects the parameter type in a parameter type list 592. The types of parameters available in parameter type list 592 might include string, date, number and boolean. The open platform template provider may also enter a statement or question in a parameter prompt box 594 that solicits a response from the recipient, or end user, of the report. For example, the open platform template provider might ask the recipient, or end user, to “please enter a two letter state abbreviation” so that the report returns data relating to that particular state. After reviewing, printing or saving the generated report for the particular state selected, the recipient may select other states to generate state specific reports. When setting up a filter for a report, the open platform template provider associates the filter with one or more open platform template provider parameter. After the filter is set up for a report, the recipient selects or enters the parameter values to generate a report. For example, the recipient could generate a report that returns accounts for a given state. This parameter might prompt a recipient by saying, “please enter the two-letter state abbreviation for the state you want to report on.” When the recipient enters a state, only records from that state are returned. The parameters feature allows a recipient, or end user, to dynamically filter the content within the data view by state rather than creating separate template 393 for each state. The parameters feature is most often used as a way to control filters or allow a recipient or end user to enter some dynamic text into a report.

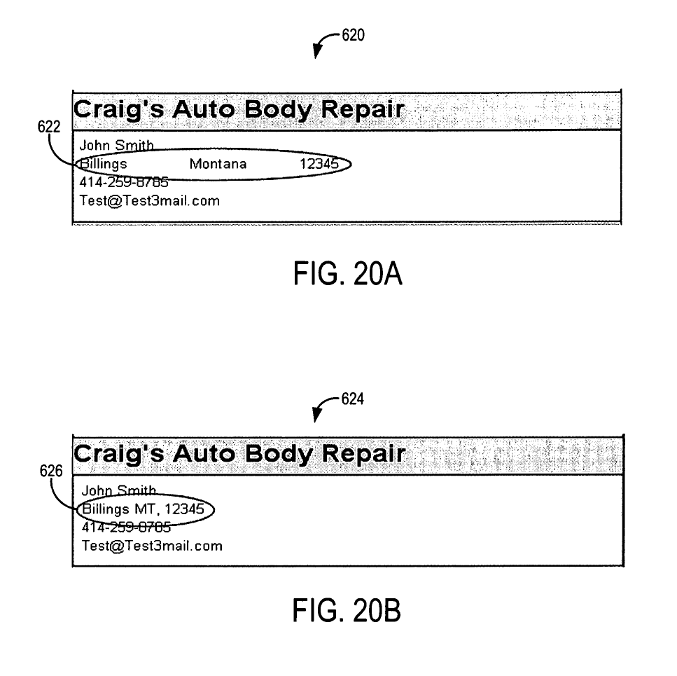

The open platform template provider may use expressions to combine or perform calculations on fields. In FIG. 20A, account contact information window 620 provides information such as the name, address, phone number and email address of the contact for that particular account. In account contact information window 620 the open platform template provider created an address line 622 by placing the city, state and zip fields next to one another on the same line. However, when the open platform template provider places the city, state and zip fields on one line, the open platform template provider will be unable to fully account for the differing lengths of these fields. The open platform template provider might attempt to guess at the appropriate size of each field, but is likely to end up with relatively large gaps between fields (e.g., large gaps between the city, state and zip text). The open platform template provider may eliminate these gaps by creating an expression that combines the city, state and zip fields to create a single field with only a single space between each item (city, state and zip). In FIG. 20B, account contact information window 624 provides an address line 626 that the open platform template provider created using an expression to combine the city, state and zip fields into one field. By using an expression the open platform template provider eliminated the large gaps that existed in address line 622.

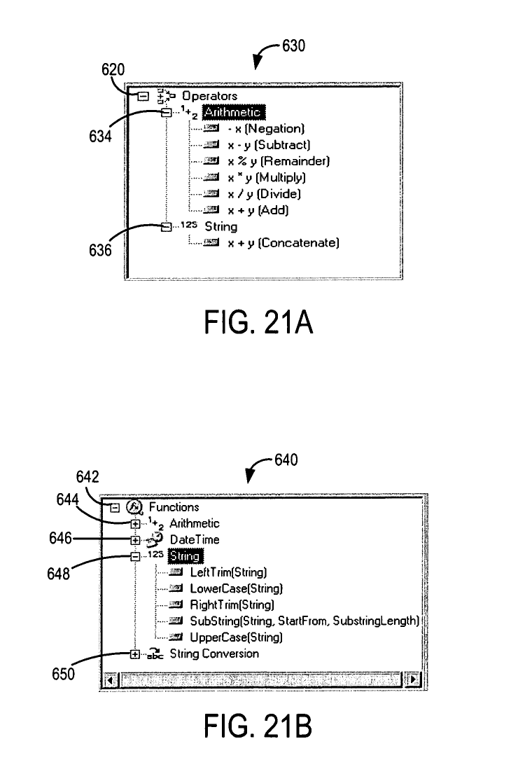

In an exemplary embodiment, the ASP provides an expression editor window where the open platform template provider may create and edit expressions. The expression editor window includes a list of available operators and functions that can be used to create expressions. FIG. 21A shows an operator section 630 which contains an operator list 632. Operator list 632 contains an arithmetic operator list 634 and a string operator list 636. Arithmetic operator list 634 includes operations such as addition, subtraction, multiplication, divisions, etc. String operator list 636 includes string combination (concatenation). FIG. 21B shows a function section 640 which contains a functions list 642. Function list 642 contains an arithmetic function list 644, a date function list 646, a string function list 648 and a string conversion list 650.

The merge fields functionality of the system provided by the ASP allows the open platform template provider to automatically merge the data located in specified data fields (specified by data category, data view, and data field) with the template fields. More specifically, the open platform template provider may associates a data source (e.g., database, end-user input, formulas or expressions, application settings, data from other ASP applications, data from applications external to the ASP, etc.) containing information about, or intended for, multiple recipients and merge the data located in the data source with the template fields to generate a report that is customized for each recipient. The merge feature of the ASP system used in conjunction with a data source to automatically generate reports, eliminates the need to enter data by hand into the template fields. The merge feature may also incorporate other data not necessarily located in the data source, such as the current date, open platform template provider's first and last name, open platform template provider's company name, etc. This data might be provided by the ASP system (e.g., current date), by the open platform template provider's account settings (open platform template provider's first and last name, and open platform template provider's company name, etc.), by the open platform template provider entering the information in a template wizard, or by manually adjusting the settings for that particular merge session.

In an exemplary embodiment, once template 393 is created the open platform template provider may set up a distribution where the reports are automatically generated and distributed to chosen recipients without any additional intervention from the open platform template provider. The distribution schedule may be set up to distribute reports on a periodic basis, such as, daily, weekly, monthly, yearly, etc. The open platform template provider has control over a number of recurrence options to further customize the distribution, including the following:

| Recurrence | Option | Description |
|---|---|---|
| Daily | Every X day(s) | Choose this option to set the number of days between |
| | | scheduled distributions. 1 indicates every day, 2 every |
| | | other day, and so on. |
| | Every weekday | Choose this option to run the report on every weekday |
| | | (Monday through Friday). |
| Weekly | Recur every X | Set the number of weeks between scheduled |
| | week(s) on | distributions. 1 indicates that it will occur every week, 2 |
| | | every other week, and so on. |
| | Select one or | Choose the days that the schedule will be distributed on. |
| | more week | |
| | days | |
| Monthly | Day X of every | Choose this option if you want the distribution to occur on |
| | Y month | a specifically-numbered day. For example, the 15th of |
| | | every third month. |
| | | Day X specifies a particular day of the month that the |
| | | report will be distributed. Every Y month(s) indicates |
| | | the number of months between each distribution. 1 |
| | | indicates every month, 2 every-other month, and so on. |
| | The X Y of | Choose this option if you want the distribution to occur on |
| | every Z | a particular day of the week. For example, the last Friday |
| | month(s) | of every second month. |
| | | X indicates the relative week of the month in which you |
| | | want the distribution to occur, such as first, second, third, |
| | | fourth, or last. |
| | | Y indicates the day of the week that you want the |
| | | distribution to occur. |
| | | Z indicates the number of months between each |
| | | distribution. 1 indicates every month, 2 every-other |
| | | month, and so on. |
| Yearly | Every X Y | Choose this option if you want the distribution to occur |
| | | once a year on a particular numbered day of a given |
| | | month. (Such as every January 1st.) |
| | | X indicates the month that you want the distribution to |
| | | occur. Y indicates the day of the month. |
| | The X Y of Z | Choose this option if you want the distribution to occur |
| | | once a year on a particular day of the week in a given |
| | | month. For example, the last Friday in January. |
| | | X indicates the week that the distribution will occur. Y |
| | | indicates the day of the week. Z indicates the month. |

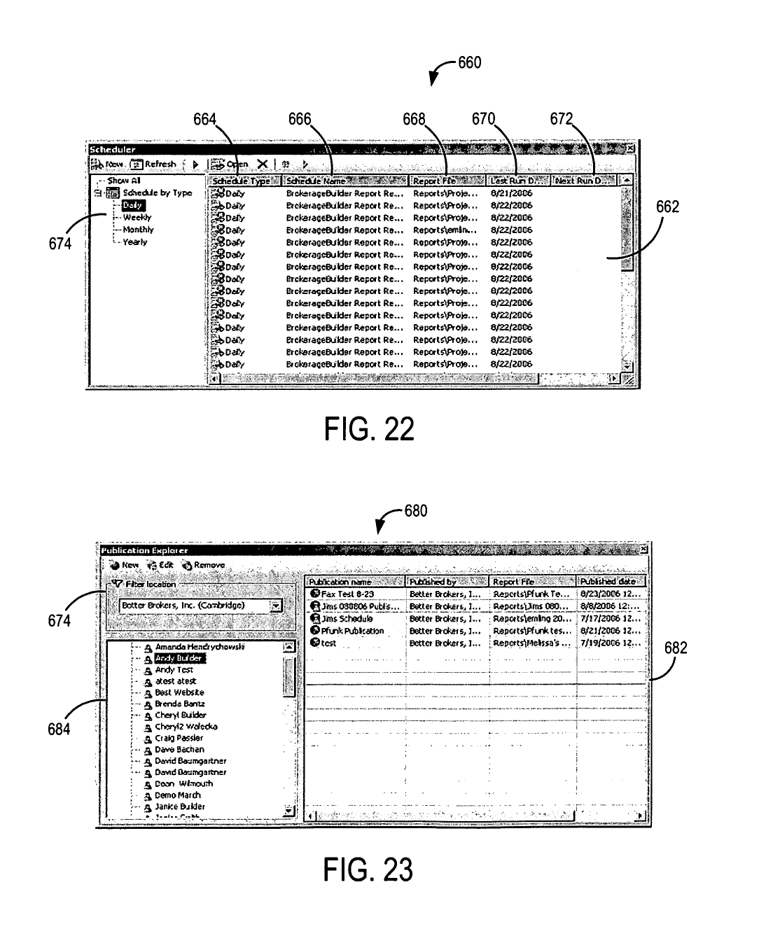

The reports may be delivered to recipients as email attachments in whichever format the open platform template provider chooses. The scheduled reports are generated immediately prior to distribution, therefore, the data in the reports is current. In an exemplary embodiment, the ASP provides the open platform template provider with a schedule explorer window 660 in FIG. 22 where the open platform template provider may create and manage distribution schedules. From schedule explorer window 660 the open platform template provider may review the list of scheduled reports, pause and start a scheduled distribution, schedule a report for distribution, edit an existing schedule, delete an existing schedule, and distribute a report on-demand. Schedule explorer window 660 displays the schedules in a schedule explorer list 662 that may include informational headings such as, a schedule type heading 664, a schedule name heading 666, a report file heading 668, a last run date heading 670, a next run date heading 672, an author heading, etc. The list of schedules may be sorted by any of the headings (e.g., sort by schedule name heading 666). In schedule explorer window 660 the open platform template provider may filter the list of schedules by showing only the schedules that meet the selected criteria. For example, FIG. 22 shows a filter by type section 674 that allows the open platform template provider to display in schedule explorer list 662 only those lists that corresponding to the schedule type selected.

When creating a schedule, the open platform template provider must specify a variety of information about the scheduled distribution, such as, the report to distribute, report name, report format, schedule recurrence, list of recipients, distribution email, and confirm schedule details. In an exemplary embodiment the ASP provides a schedule wizard to assist the open platform template provider in creating a schedule. The wizard displays a primary information window where the open platform template provider enters a descriptive schedule name. The open platform template provider is then prompted to select a report file and is given the opportunity to browse to the location of the desired report file. After selecting the report file, the open platform template provider is then prompted to select the desire format, which includes formats such as, Portable Document Format (PDF), Microsoft® Excel® Workbook (XLS), Tagged Image File Format (TIFF), HTML, Comma Separated File (CSV), etc. The open platform template provider is then prompted to select the schedule type, which is the frequency of recurrence for report distribution. The open platform template provider selects a recurrence patter, such as, daily, weekly, monthly, or yearly. Once the pattern is selected the open platform template provider selects the options for the specific recurrence (e.g., if weekly is chosen the open platform template provider sets how many weeks the schedule occurs and on which days it is distributed). The open platform template provider then selects a start date and has the option of also selecting an end date. The open platform template provider is then prompted to identify the recipients of the schedule distribution. The recipients may be grouped in a number of different ways, such as, location, plan status, plan type, or any other criteria. Once the list of recipients is generated the open platform template provider is prompted to configure email settings. The open platform template provider may configure the email settings so that recipients are blind carbon copied (Bcc) in the email so that a recipient will not see the other recipients of the message. The open platform template provider may enter the desire subject line and email body to be sent to each recipient. Once a distribution schedule is created the open platform template provider may revisit the settings to make any necessary changes. If a report is scheduled for distribution sometime in the future, but the open platform template provider wishes to distribute an updated copy now, then the open platform template provider may run the schedule in an on-demand fashion. The on-demand feature puts the request for distribution at the top of the distribution queue so that it will be generated and distributed as soon as possible. The open platform template provider may select whether there is a fee for utilizing template 393 or whether template 393 usage is free.

In addition to scheduling reports, the open platform template provider may distribute reports by using a publishing feature provided by the ASP. The publishing feature is ideally suited for situations where reports are needed on-demand at irregular intervals. In these types of situations, running a scheduled report in-demand can be cumbersome. Using the publishing feature the open platform template provider does not actually create the report output for each intended recipient. Instead, the open platform template provider creates a link through which the intended recipient can generate the report when needed. When the intended recipient selects the link, they must fill out certain parameters that are set up for the report by the open platform template provider, such as, reporting period, other filters, or payment mechanisms. The report is then placed in the queue and distributed to the intended recipient via email. The report may also be distributed in other ways to the recipient, for example, the report could be posted to the recipients online account, it could be appear in a web browser on the recipients computer shortly after the recipient requests the report (i.e., the recipient would be prompted to wait for the report being generated), the report could appear on the recipients computer using an application program, such as, Adobe® or Microsoft® Word®), after the recipient request the report, or the report could be downloaded to the recipients computer shortly after the request. To assist the open platform template provider in setting up and managing published reports, the ASP provides a publication explorer window 680 in FIG. 23 where the open platform template provider may create and manage published reports. In publication explorer window 680 the open platform template provider may view a list of currently published reports in a publication list 682, filter publication list 682, create a new report publication, edit an existing publication, remove a publication, etc. Publication list 682 includes all publications that have been set up for the recipients in publication recipient list 684. If an individual recipient has been selected from publication recipient list 682 then publication list 680 will only contain publications for that particular recipient. Publication recipient list 682 contains all of the recipients that are members of a location selected in filter location section 686. In filter location section 686 the open platform template provider may select a single filter location or multiple filter locations to include in publication recipient list 682.

To publish a report, the open platform template provider must define a new publication in publication explorer window 680. A publication is connected to a single report; however, a single report can be created for a number of intended recipients. Additionally, the open platform template provider may have multiple publications that all refer to the same report. The open platform template provider may want to do this if the open platform template provider wants to have different expiration dates for different recipients. For example, the open platform template provider might give one set of recipients unlimited access to a report, but want to the report to expire after one month for another set of end-users. To create a publication, the ASP provides a publish report wizard. The publish report wizard prompts the open platform template provider to enter a descriptive name for the publication. The open platform template provider is then prompted to select a report file and is given the opportunity to browse to the location of the desired report file. After selecting the report file, the open platform template provider may select an expiration date of the publication. The open platform template provider is then prompted to identify the recipients of the publication. The recipients may be grouped in a number of different ways, such as, by location, by agency, by plan status, plan type, or any other criteria. After the publication is created the open platform template provider may edit its settings and properties. Once a publication expires, it is not automatically removed from the publication explorer list. It can be updated and reused by the open platform template provider or the open platform template provider may chose to manually delete the file from the publication list to avoid clutter.

In an exemplary embodiment the ASP provides the open platform template provider with the ability to create static and dynamic account groups. Static groups change only when the open platform template provider updates it, while dynamic groups add an drop recipients as the recipients information changes. This means that a open platform template provider may create a report that uses filters to automatically pull out intended recipients based on certain selected criteria. Therefore, if dynamic groups are used the open platform template provider does not need to manually update the list of recipients prior to distribution because it is done automatically

The ASP portal provides an open platform upon which users can upload their templates 393 for generating reports. The template's industry focus, intended use, data fields and other aspects are determined by the open platform template provider that created template 393. The open platform template provider that uploads template 393 can populate the template's fields by hand or use ASP's merge feature to merge the data and the fields in uploaded template 393. During or after the upload, the open platform template provider may chose to keep uploaded template 393 private so that only the open platform template provider may use template 393, or the open platform template provider may chose to make template 393 public so that anyone with access to the ASP's template section may use template 393 (e.g., the ASP template section may be password protected or may be available to anyone with an internet connection). The open platform template provider may also allow limited access to template 393 in a number of ways including, but not limited to, the following: allowing only identified entities to use template 393; allowing only those within the open platform template provider's agency to use template 393; allowing only those who are members of a particular organization or on-line community to use template 393; allowing only those that complete and submit and on-line survey to use template 393; allowing only those that register an account to use template 393; allowing only those that pay a fee to use template 393; allowing only those that are customers of the open platform template provider to use template 393; allowing only those that have the correct password to use template 393; setting a time limit for using template 393; or setting a number of uses limit for using template 393. The open platform template provider may chose to set up permissions on template 393 so that certain aspects cannot be modified, such as a logo or some form of advertisement displayed on template 393 and/or generated report. The open platform template provider may chose to make template 393 downloadable or accessible exclusively through the ASP.

Once template 393 is uploaded and stored in the template library, the open platform template provider that uploaded template 393 may choose to make template 393 available to others within the open platform template provider's agency so that other employees or agents can use distribute similar items to their clients. One advantage of this arrangement is that an agency will appear more professional by distributing uniform items to all of its clients regardless which agent manages an account. In an exemplary embodiment the open platform template provider may use uploaded templates 393, and/or templates 393 created using the ASP tools, as part of an express campaign described in detail above.

According to other various alternative and exemplary embodiments, the data management application may be used by entities other than application service providers. For example, the application may be configured for use by a company for collaborating in real-time with its customers (or suppliers or other parties), such as on the creation of certain documents, presentations, or other files.

It is important to note that data management system 60 and content generation engine 61 are illustrated as an integrated system. However, data management system 60 and content generation engine 61 may also be separate system with minimal, limited or no communication with each other.

It is important to note that the term “data management system” is intended to be a broad term and not a term of limitation. According to various alternative and exemplary embodiments, the data management system may be used with any of a variety of different hardware, software, programs, applications, etc. and is not intended to be limited to use by application service providers, but may be used by one or more of a variety of different entities in any arrangement where the functionality of the data management application (e.g., the addition of out of network files to a open platform template provider's Windows Explorer interface, the ability to manipulate remote files in the same way local files are manipulated, etc.) is desirable.

The disclosure is described above with reference to drawings. These drawings illustrate certain details of specific embodiments that implement the systems and methods and programs of the present disclosure. However, describing the disclosure with drawings should not be construed as imposing on the disclosure any limitations that may be present in the drawings. The present disclosure contemplates methods, systems and program products on any machine-readable media for accomplishing its operations. The embodiments of the present disclosure may be implemented using an existing computer processor, or by a special purpose computer processor incorporated for this or another purpose or by a hardwired system.

As noted above, embodiments within the scope of the present disclosure include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the disclosure are described in the general context of method steps which may be implemented in one embodiment by a program product including machine-executable instructions, such as program code, for example, in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present disclosure may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, servers, minicomputers, mainframe computers, and the like. Embodiments of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the disclosure might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules, and other data for the computer.

It should be noted that although the flowcharts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the disclosure have been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

What is claimed is:

1. A computer-implemented data processing system, comprising:
a database;
a file server coupled to the database;
a template engine coupled to the file server, the template engine being configured to create a plurality of insurance brokerage industry templates;
an application service provider interface logic coupled to the file server and the template engine, the application service provider interface logic being configured to receive commands via a communication network from a client device to access an open platform template library in the database and retrieve one of the plurality of insurance brokerage industry templates.

2. The computer-implemented data processing system of claim 1, wherein the interface logic is configured to cooperate with the client device to cause at least one of the plurality of insurance brokerage industry templates to be displayed.

3. The computer-implemented data processing system of claim 1, wherein an open platform template architecture is accessible to an open template platform provider.

4. The computer-implemented data processing system of claim 1, wherein an open platform template provider creates at least one of the plurality of insurance brokerage industry templates.

5. The computer-implement data processing system of claim 1, further comprising a payment engine, the payment engine being configured to monitor an insurance brokerage industry template usage, wherein the payment engine creates invoices for the insurance brokerage industry template usage.

6. The computer-implemented data processing system of claim 1, wherein the application service provider interface logic receives at least a file command from a plurality of client devices and cooperates with the plurality of client devices to transmit at least one of the plurality of insurance brokerage industry templates based on a control signal sent by a data access layer logic.

7. The computer-implemented data processing system of claim 1, wherein a search logic being configured to select a template grouping from at least one of a benchmark surveys and statistics, employee communications and education, sales tools, employer tools, wise and well, sales concepts, loss control, marketing tools, cost containment, or regulatory compliance.

8. The computer-implemented data processing system of claim 1, wherein the template engine being configured to create a plurality of insurance brokerage industry brochures by merging the plurality of insurance brokerage industry templates with at least a client data.

9. A computer-implemented data processing method for database management, comprising:
storing at least a data file in an application service provider database;
storing at least an insurance brokerage industry template in the application service provider open platform template library;
receiving a template command from a client devices to an application service provider server; and
transmitting the insurance brokerage industry template.

10. The computer-implemented data processing method of claim 9, wherein an open platform template architecture is accessible to an open template platform provider.

11. The computer-implemented data processing method of claim 9, wherein an open platform template provider creates at least one of the plurality of insurance brokerage industry templates.

12. The computer-implement data processing method of claim 9, further comprising a payment engine, the payment engine being configured to monitor an insurance brokerage industry template usage, wherein the payment engine creates invoices for the insurance brokerage industry template usage.

13. The computer-implement data processing method of claim 9, further comprising merging the insurance brokerage industry template with a client data to create a brochure.

14. The computer-implemented data processing method of claim 9, further comprising modifying the brochure and storing a modified brochure in the application service provider database.

15. The method of claim 9, wherein an application service provider interface logic receives a plurality of template commands from a plurality of client devices and cooperates with the plurality of client devices to transmit the insurance brokerage industry template based on a control signal sent by a data access layer logic.

16. A computer-implemented data processing system, comprising:
a database;
a file server coupled to the database;
a template engine coupled to the file server, the template engine being configured to create a plurality of insurance brokerage industry templates;
an open platform content template logic;
an application service provider interface logic coupled to the file server and the template engine, the application service provider interface logic being configured to receive commands via a communication network from a client device to access at least one of the plurality of insurance brokerage industry templates and to cooperate with the client device to cause the at least one of the plurality of insurance brokerage industry templates to be displayed on the client device.

17. The computer-implemented data processing system of claim 16, wherein an open platform template architecture is accessible to an open template platform provider.

18. The computer-implemented data processing system of claim 17, wherein an open platform template provider creates at least one of the plurality of insurance brokerage industry templates.

19. The computer-implemented data processing system of claim 18, further comprising a payment engine, the payment engine being configured to monitor an insurance brokerage industry template usage; and
a report logic, the report logic being configured to generate reports;
wherein the payment engine creates invoices for the insurance brokerage industry template usage;
wherein the report logic generate an insurance brokerage industry template usage report.

20. The computer-implemented data processing system of claim 19, wherein the application service provider interface logic receives a plurality of template commands from a plurality of client devices and cooperates with the plurality of client devices to transmit the insurance brokerage industry template data file based on a control signal sent by a data access layer logic.

21. The computer-implemented data processing system of claim 20, wherein the payment engine electronically transfers funds from an insurance brokerage industry template user account to an open platform template provider account based on the insurance brokerage industry template usage.

22. The computer-implemented data processing system of claim 21, wherein the application service provider interface logic being configured to select a template grouping from at least one of a benchmark surveys and statistics, employee communications and education, sales tools, employer tools, wise and well, sales concepts, loss control, marketing tools, cost containment, or regulatory compliance.

23. The computer-implemented data processing system of claim 22, wherein the template engine being configured to create a plurality of insurance brokerage industry brochures by merging the plurality of insurance brokerage industry templates with at least a client data.

24. The computer-implemented data processing system of claim 23, wherein the reporting logic being configured to select one report data from insurance brokerage industry template usage, insurance brokerage industry template rankings, related insurance brokerage industry template usage, insurance brokerage industry template campaign usage, frequency of insurance brokerage industry utilization, insurance brokerage industry template creation date, insurance brokerage industry template modification date, or insurance brokerage industry template ratings.
